(19) United States
(12) Patent Application Publication
(10) Pub. No.: US 2007/0221324 A1
(43) Pub. Date: Sep. 27, 2007

(54) Thermoforming, with applied pressure and dimensional re-shaping, layered, composite-material structural panel

(75) Inventors: Russell A. Monk, Salem, OR (US); Lance A. Hicks, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 11/726,964

(22) Filed: Mar. 24, 2007

Related U.S. Application Data
(60) Provisional application No. 60/785,596, filed on Mar. 24, 2006.

(51) Int. Cl. B32B 37/00

(52) U.S. Cl. 156/308.2

(57) ABSTRACT

A method utilizing elevated temperature and applied pressure to form a layered, composite-material structural panel including (a) establishing a layer-stack assembly in the form of a pre-consolidation expanse having everywhere an independent, location-specific, pre-consolidation local thickness T, and including at least a pair of confronting, different-thermoformable-material layers, (b) heating the assembly to a thermoform temperature, (c) compressing the heated assembly to create a thermal bond between the two layers, and to consolidate the assembly into a post-consolidation expanse having everywhere an independent, location-specific, post-consolidation, local thickness t which is less than the respective, associated, pre-consolidation local thickness T, and (d) cooling the consolidated assembly to a sub-thermoform temperature to stabilize it in its consolidated condition.

### CROSS REFERENCE TO RELATED APPLICATIONS

This application claims priority to currently co-pending U.S. Provisional Patent Application Ser. No. 60/785,596, filed Mar. 24, 2006 for “Thermoform Layered Structure and Method”. The entire disclosure content of this provisional application is hereby incorporated herein by reference.

### BACKGROUND AND SUMMARY OF THE INVENTION

This invention pertains to the thermoforming of a lightweight, strong, layered, composite-material structural panel through the combined use of heat and pressure to consolidate, thermally bond, and dimensionally re-shape an initially unconsolidated pre-assembly of selected thermoformable layer materials, including at least one, relatively thick, very low density (such as foam) layer which provides structural bulk, and at least one, thermally-bonded-thereto, relatively thin, significantly higher density layer which contributes structural strength. It also pertains to such methodology which further contemplates the incorporation into a thermoformed panel, at certain locations, and for various functional reasons, of additional layer material(s) which are not necessarily thermoformable materials.

There is significant interest in the development and manufacture of new kinds of lightweight, robust and inexpensive structural panels suitable for use in many different kinds of applications, such as in car doors, truck trailer floor and side panels, residential-housing and commercial-building doors, and so on. In these applications, as well as in others, lightweightness, stable stiffness, excellent load-bearing strength, producible good and smooth surface finish, pronounced surface scuff and abrasion resistance, low cost, and ease and safety of manufacture, rank high on the usual list of material “wants” for such panels.

There is also strong companion interest in the creation of such panels in a manner which minimizes the costs and complexities of, by avoiding, after-panel-formation three-dimensional shaping, or configuring (also called “topographing” herein), to give a particular panel a special three-dimensional configuration, such as a complex or simple bend, a complex surface topography, a certain edge definition, etc. With respect to all of these considerations, there is further an important interest in producing such panels in a manner which respects the environment, and which also, as just suggested above, subjects all manufacturing personnel to as little risk of injury and health hazard as possible.

The present invention offers a methodology which uniquely and thoroughly addresses all of these matters. In particular, proposed by the invention, in its preferred and best mode manner of implementation, is a structural-panel thermoforming-only methodology which utilizes elevated temperature and applied pressure to produce a layered, composite-material structural panel, and does so preferably to the point of full panel completeness—i.e., a completeness, including complex three-dimensional shaping, which requires substantially no after-formation shaping, or other, processing.

The basic steps of this methodology include (a) establishing a pre-panel layer-stack assembly in the form of a pre-consolidation expanse having everywhere an independent, location-specific, pre-consolidation local thickness T, and including at least a pair of confronting, different-thermoformable-material layers, (b) heating the assembly to a thermoform temperature, (c) compressing the heated assembly to create a thermal bond between the two layers, and to consolidate (shape-change) the assembly into a post-consolidation expanse having everywhere an independent, location-specific, post-consolidation, local thickness t which is less than the respective, associated, pre-consolidation local thickness T, and (d) cooling the consolidated assembly to a sub-thermoform temperature to stabilize it in its consolidated condition.

As one will note from the basic methodology procedure just set forth above, two independent variables, T and t, are employed herein to describe the practice of the invention. Definitionally, the variable T describes what is called the location-specific, overall, pre-consolidation panel pre-assembly thickness measured at a particular point, or location, on one of the broad surfaces of that assembly, i.e., a thickness measured along a line passing through that point, which line is substantially normal to the surface of the panel pre-assembly at that point. The variable t describes a similarly measured “local”, or location-specific, thickness of a fully consolidated, thermoformed, finished panel.

With respect to each specific location on a panel assembly, and in accordance with practice of the present invention, t is always smaller than T as a result of the important fact that all regions of such an assembly are always intentionally irreversibly reduced in thickness, i.e., shape-changed, or re-shaped, during assembly compression. This re-shaping situation plays an important role in promoting the creation of an extremely strong thermal bond between the relevant, thermoformable assembly layers. In this context, always, the thicker foam layer compresses significantly, and the fibre-reinforced layer, only very modestly, and sometimes almost imperceptibly.

As will be seen, a pre-consolidation panel assembly may have either a uniform, or allover, location-specific thickness characteristic T which is substantially the same everywhere, or a non-uniform, differentiated location-specific thickness characteristic which differs at different locations. This same statement about “local” thickness sameness or differentiation applies also to the location-specific t thickness characteristic(s) of a post-consolidated, fully formed structural panel.

It is this important concept, linked to re-shaping compression, and enabled in the context of full panel creation via thermoforming, which lies at the heart of the capability of practice of the present invention to produce structural panels having the various different kinds of three-dimensional bending and topographing mentioned earlier A central practice-modality of the present invention focuses attention on the creation, as just generally outlined, of a key, two-layer panel structure, one of which layers is relatively thick (in comparison to the other layer) and formed of a low-density, lightweight, thermoformable thermoplastic foam which gives appropriate structural bulk with little weight to a finished panel, and the other of which layers is relatively thin (in relation to the first-mentioned layer) and formed of a higher density, oriented-fibre-reinforced thermoplastic polymer.

While different thermoformable materials may well be chosen for use in such layers by those practicing this invention, we have found currently that two particularly preferred materials include a polyethylene terephthalate (PET), closed-cell, 6-24# foam product made by Sealed Air Corporation in Saddlebrook, N.J. for the lightweight foam layer, and a fiber-reinforced-polymer, composite sheet material, taking the form of oriented continuous fibers (or strands) in a matrix of a thermoplastic polymer, and sold under the product trademark Polystrand® made by a company of the same mane in Montrose, Colo. for the higher-density layer. The polymer used in this sheet material is preferably either polypropylene or polyethylene, though it may also be some other suitably chosen thermoformable plastic material. In the present description of the invention, its practice is described in the context of using a Polystrand® sheet material where the fibres, or strands, are made of E-glass, and the associated thermoplastic polymer is polypropylene.

The above-outlined methodology, during the compression step, uniquely accommodates, as desired, special, three-dimensional configuring of a final, completed panel. Simple as well as complex bends may be created in a panel, and also different kinds of panel-surface and panel-edge topographies may be introduced completely during the thermoformation procedure, per se.

Additionally, panel formation which is practiced in accordance with the present invention uses no adhesive to bond panel layers, and thus can be implemented without its practice generating troublesome environmental and human-health problems associated with the release of volatile organic compounds.

The just-above-discussed two-layer formation procedure is employed in what can be thought of as being a central way with respect to the thermoforming of a composite structural panel in accordance with the invention. In particular, while, as will be seen shortly, various different kinds of specific, composite panel structures, including multi-layer (more than two-layer) structures, may be fabricated via practice of the invention, each of these structures, as contemplated by the invention, will all include within them the particular two-layer assembly which has been so far generally described.

These and various other features and advantages which are offered by the invention will now become more fully apparent as the detailed description of it below is read in conjunction with the accompanying drawings.

### DESCRIPTION OF THE DRAWINGS

FIG. 1 is a simplified and structurally fragmentary illustration of the basic methodologic steps of the present invention presented in the physical context of a two-layer, composite structural panel which has been thermoformed in accordance with a preferred and best mode manner of practicing the invention. Each of the two layers in this panel is formed of a thermoformable material which specifically differs from the thermoformable material used in the other layer. Objects shown in this figure, as is true with respect to objects shown all of the other drawing figures, are not drawn to scale.

FIG. 2 is a somewhat more detailed, and partially fragmentary, view, having left and right sides which differently picture the methodology of the present invention in the structural context of two other kinds of basic, composite structural panels that have been made as three-layer sandwich structures in accordance with practice of the invention. Each of the three layers in these two panels is formed of a thermoformable material, with such thermoformable material that is used in the two outer layers being the same, and differing from the thermoformable material employed in the intermediate core layer.

FIGS. 3-6, inclusive, are high-level schematic and simplified views having left and right sides, and which picture, with regard to these four figures, respectively, four different basic and important panel-thermoforming approaches, or methodologic invention facets, that are offered and made possible by practice of the present invention.

FIG. 7 is a fragmentary, schematic, side elevation having left and right sides which, in a somewhat more detailed fashion, illustrate one specific application of the invention practice that is related to the content of FIG. 5.

FIG. 8 is a fragmentary, schematic, side elevation having left and right sides which, in a somewhat more detailed fashion, illustrate another specific application of the invention practice—this application practice being related to the content of FIG. 4.

FIG. 9 illustrates, schematically and fragmentarily, a batch manner of implementing the practice of the present invention.

FIG. 10 illustrates, schematically and fragmentarily, a continuous-flow manner of implementing the practice of the present invention.

### DETAILED DESCRIPTION OF THE INVENTION

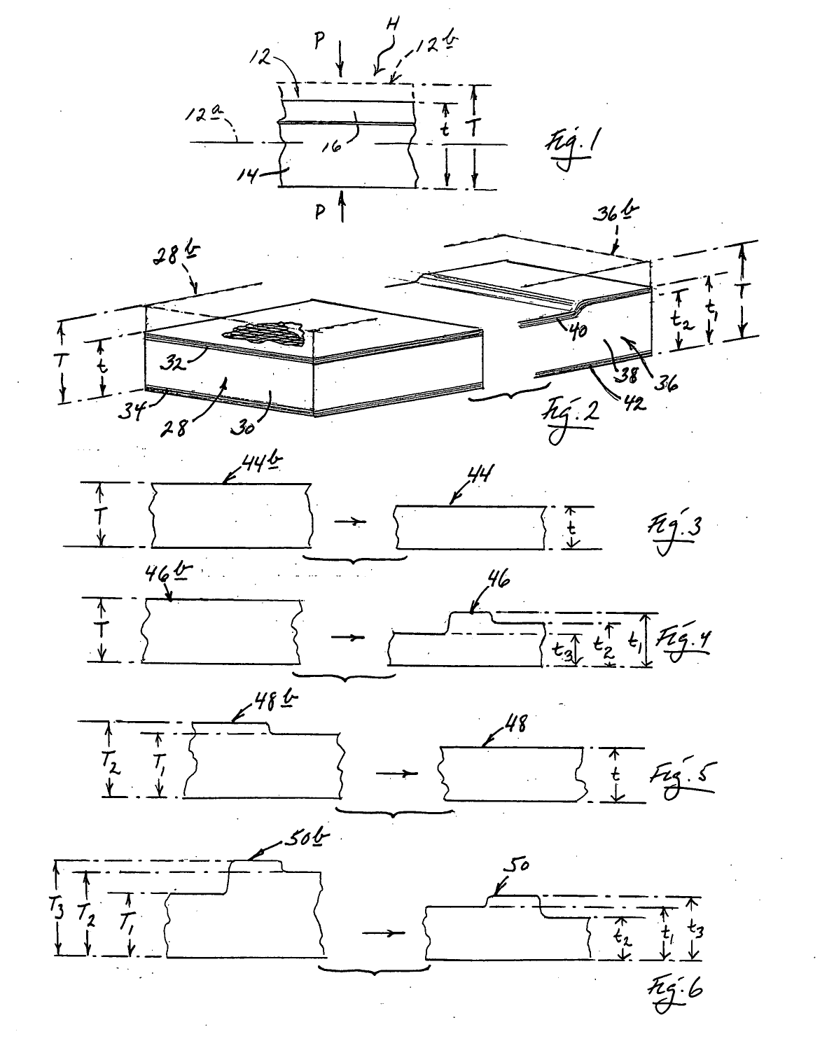

Beginning with FIG. 1, shown generally and fragmentarily at 12 is a two-layer, generally planar, composite structural panel which, in accordance with a preferred and best mode manner of practicing the present invention, has been thermoformed to the finished and stably consolidated condition in which it appears in solid lines in this figure. More particularly, panel, or expanse, 12, which lies in FIG. 1 in a plane 12a, has been formed via an applied, cooperative combination of controlled heat (H) and compressive, re-shaping pressure (compression) (P), to consolidate, to bond thermally, and to thickness-size what was initially a somewhat thicker, pre-consolidation, pre-panel, layer-stack assembly, or expanse, 12b (see the dashed lines). Initial layer-stack assembly 12b, as well as finished panel 12, is made up of two confronting and next-adjacent layers 14, 16 of different, selected thermoformable materials. Thicker layer 14, as illustrated herein, is formed of the specific PET foam material mentioned earlier in this text, and, for illustration purposes, has an initial, herein substantially uniform, thickness of about ⅝-inches. Layer 16, which preferably includes several (such as about twelve) sub-layers (not specifically shown in FIG. 1), is formed, in each sub-layer, of the specific Polystrand( product identified earlier, and, for illustration purposes herein, has, overall, a substantially uniform thickness of about 0.16-inches.

There is no adhesive placed between layers 14, 16.

As a consequence of these purely illustrative layer dimensional conditions, pre-consolidation layer-stack 12b has a substantially uniformly distributed, location-specific T characteristic everywhere of about 0.785-inches. After appropriate heat application (preferably in the range of about 350-400° F. as a thermoform temperature), and pressure application (preferably in the range of about 5-30-psi), to layer-stack 12b, and following resulting consolidating and thermal bonding, holding-in-place and cooling (preferably to about 100° F. as a sub-thermoform temperature) of layers 14, 16, finished panel 12 has a substantially uniformly distributed, stable, location-specific t characteristic everywhere of about 0.655-inches. This t condition has resulted from a stabilized thickness reduction in the panel assembly of slightly more than about ⅛-inches—an amount of re-shaping thickness change which has been found to be appropriate in substantially all panel thermoforming operations, regardless of actual, starting, local-specific T conditions.

Regarding compression-produced thickness reduction, we have found that such a thickness reduction takes place substantially, though not necessarily, entirely in the thicker PET layer. And, we have found further that, at a minimum, an attendant, about ⅛-inches compression, or thickness, reduction, in the entire, overall assembly works well to achieve a very robust thermal bond between the layers.

Thus, FIG. 1 fully illustrates the fundamental practice of the present invention in the context of forming what ultimately becomes a final, substantially uniform-thickness structural panel, starting from an initially substantially uniform-thickness pre-consolidation layer-stack assembly.

As will be appreciated, the content of FIG. 1 thus illustrates practice of the invention in the fundamental form of including the steps of (a) establishing a pre-consolidation, layer-stack assembly in the form of a pre-consolidation expanse having everywhere a location-specific, pre-selected, pre-consolidation, independent, local thickness T, and including at least a pair of confronting, next-adjacent, different-thermoformable-material layers, (b) heating the established assembly to a predetermined thermoform temperature, (c) compressing the heated assembly to consolidate it so as (1) to form a post-consolidation expanse having everywhere a location-specific, pre-selected, post-consolidation, independent, local thickness t which is less than the respective, associated, pre-selected, pre-consolidation local thickness T, and which takes the form of the desired, predefined final panel-thickness characteristics, and (2) to create a thermal bond between the two layers, (d) cooling the consolidated assembly to a predetermined sub-thermoform temperature to stabilize it in its consolidated condition, and (e) by such cooling, completing, substantially, the formation of the intended structural panel.

In addition to the steps just expressed above, we have found that, in certain instances, it is useful to pre-roughen, as by planing-cutting, that surface of the PET foam layer which confronts the strand-reinforced layer. This seems further to enhance the strength of the thermal bond which develops between these two layers. Perhaps this comes about because of the resulting breaking open of the relevant cell walls in the foam cells that face the strand-reinforced layer. We have also found that, in order fully to create a finished structural panel with dimensionally precise perimetral edges, it may be important to constrain appropriately, as with a rigid form, the lateral boundaries of a pre-consolidated layer stack.

Shifting attention to FIGS. 9 and 10, here we illustrate schematically two, different, representative, practical manners of fabricating (thermoforming) a two-layer panel, such as panel 12, from a pre-consolidation layer-stack, such as layer-stack 12b, employing the several successive, cooperative methodology steps described above. FIG. 9 pictures a batch method of fabrication, and FIG. 10, a continuous method. In each case, fabrication description proceeds with reference numeral/letter 12b being used to designate a pre-consolidation layer-stack which, in the case of FIG. 10, is an extruded/merged, flowing, “continuity” layer-stack (formed as will be described shortly), and with reference numeral 12 being used to designate a consolidated structural panel, or, in the case of FIG. 10, a flowing “panel-ready” mat which may ultimately be, for example, cross-trimmed, as appropriate.

In FIG. 9, layer-stack 12b is assembled, and placed in the base 18a of a rigid rectangular form 18, which also includes an initially separated top 18b, and four appropriate sides, such as the two sides shown at 18c. Top 18b sits on the top of the layer-stack, and is initially spaced above the base, as indicated by the two dash-dot lines shown to the right of form 18, by a distance of at least about ⅛-inches. The top and base elements, per se, of mold 18 are substantially planar and parallel to one another. In any suitable fashion, top 18k is guidingly associated with base 18a, whereby a vertical compressive force (i.e., vertical as seen in FIG. 9) applied to the layer-stack will cause the form top to move straight down toward the form base.

This arrangement is then placed in an oven 20 wherein heat is applied to raise the layer-stack to the earlier-mentioned thermoform temperature, whereupon appropriate softening of the thermoformable layer materials occurs.

Next, the heated layer-stack assembly is shifted out from oven 20, and form 18 is subjected to compression, as generally illustrated, to close the top and base of form 18 upon themselves, i.e., to “bottom-out” (see dash-dot line 18d), thus to compress and consolidate the layers in the layer-stack assembly, to reduce the thickness of the assembly accordingly by the amount of the initial vertical spacing initially existing between the two, principal form components, and to create a thermal bond between the layer-stack layers. The form sides constrain the sides of the layers from shifting laterally, and the heated, and now consolidated layer-stack assembly is shaped and sized to the dimensional condition of a properly finished structural panel.

Finally, and while the form is continued to be held appropriately closed, the entire heated mass is cooled to the earlier mentioned sub-thermoform temperature, thus to rigidify and stabilize the layer assembly now as a full finished and dimensionally stable-condition structural panel, as contemplated.

In the continuous-fabrication approach shown in FIG. 10, PET layer material is extruded by an extruder 22 to have the appropriately dimensioned rectangular cross section, is appropriately merged with a flowing “sheet” of the strand-reinforced layer material 16 which is paid out from a feed roll 24, and the merged combination (a layer-stack 12b), is introduced into a machine 24 which is designed in any suitable manner to perform heating, compressing and cooling in much the same “general ways” described above with respect to the FIG. 9. Suitable cross-sectional perimeter restraint (see the dash-double-dot lines in FIG. 10) is supplied inside that part of machine 26 wherein compression takes place to perform, in the “flow” world of machine 26, the equivalent of the lateral-restraint function supplied by form sides 18c in the “batch” world of form 18. If desired, pre-heating of the two layer materials may be accomplished in extruder 22 and in the feed-roll structure. Cooled, consolidated and rigidified structural panel material 12 emerges from machine 26, and may be cross-trimmed to “finish it” in the sense of cross-cutting, for example, to length (relative to its flow direction as seen in FIG. 10).

Turning attention now to the remaining drawing figures, FIG. 2, on its left and right sides, respectively, shows, fragmentarily, two different structural panels 28, 36 which have been thermoformed in accordance, essentially, with practice of the invention as so far described. Panel 28 has been thermoformed from a layer-stack 28b shown in dashed lines, and includes three thermoformable layers 30, 32, 34. Layer 30 is a PET-material layer and each of layers 32, 34 is formed of fibre-reinforced Polystrand) material, with each of these layers herein having a plurality (about twelve) of sub-layers not specifically labeled. The uppermost Polystrand(& sublayer in panel 28 has been broken open to show, generally, its fibre-reinforcing strands 32a combined with its thermoplastic, polypropylene polymer 32b.

As can be seen, layer-stack 28b has a uniform, allover, location-specific assembly thickness T. In the thermoformation of panel 28, and during the compression stage of the methodology of the present invention, compression has occurred to produce final structural panel 28 with an allover consolidated location-specific thickness t. The difference between T and t herein is about ⅛-inches.

Thus, the left side of FIG. 2 shows an end-result structural panel which is somewhat like previously described panel 12, except that panel 28 is doubly faced with thin layers of high-density fibre-reinforced Polystrand® material—a structural panel style which has been found to offer special utility in many current applications.

Structural panel 36 on the right side of FIG. 2 has been thermoformed from a pre-consolidation layer stack 36b having an allover, location-specific assembly thickness T. Panel structure 36, which includes a PET-material layer 38, and a pair of opposite surfacing, plural sub-layer (again about twelve) Polystrand® layers 40, 42, as finally configured, has a topographed upper surface, which may be thought of as being a stepped-shaped upper surface, with two different location-specific consolidation thicknesses t₁, t₂.

The difference between T and t, herein is about ⅛-inches. The difference between T and t₂ is greater than ⅛-inches. Such a single-faced, stepped-thickness finished structural panel may be created conveniently during compression, in, for example, a form somewhat like form 18 shown in FIG. 9, where the base surface or structure of the form is planar, and the top of the form is pre-shaped to contain an appropriate complementary stepped configuration, whereby compression results in the desired, topographing panel surfacing arrangement shown for panel 36.

Thus it is that FIG. 2 illustrates two different end-result structural panels, each of which includes a core PET material layer, and opposite-face surfacing layers of Polystrand® material. The thermoformation steps, as has been indicated already, include the previously discussed steps of layer-stack assembly, heating to a thermoform temperature, compression to a thickness-reduced consolidated condition, thermally bonded, as between its layers, as a consequence of such heating and compressing, and cooled to a sub-thermoform temperature to stabilize a finished structural panel in a fully consolidated, or post-consolidation, condition.

FIGS. 3-6, inclusive, each provides fragmentary side-elevation outlines of several, different, basic thermoformed structural panels made in accordance with practice of the present invention.

More specifically, FIG. 3, on its right side, shows a finished structural panel 44 having a uniform, overall, location-specific consolidated thickness t which began its life, so to speak, as a pre-consolidation layer-stack 44b having an allover, pre-consolidation, location-specific, stack-assembly thickness T.

FIG. 4 illustrates a final structural panel 46 having three different location-specific thicknesses t₁, t₂, t₃ which has begun its life as a pre-consolidation layer-stack 46b having a uniform, overall, location-specific, assembly thickness T. It should be understood that while plural-thickness, complex topographing has been shown for just one of the two broad surfaces for structural panel 46, similar, complex topographing could be created in both broad surfaces if desired. FIG. 8, to be discussed shortly, is an illustration of the generally illustrated thermoforming practice pictured in, and described with respect to, FIG. 4.

FIG. 5 illustrates a final structural panel 48 having a substantially uniform, overall, layer-specific thickness t, which has been formed from a pre-consolidation, layer-stack assembly 48b which was initially structured to have two, different location-specific, layer-stack thicknesses T₁, T₂. FIG. 7, also shortly to be discussed, provides one particular illustration of the thermoforming practice generally pictured in FIG. 5.

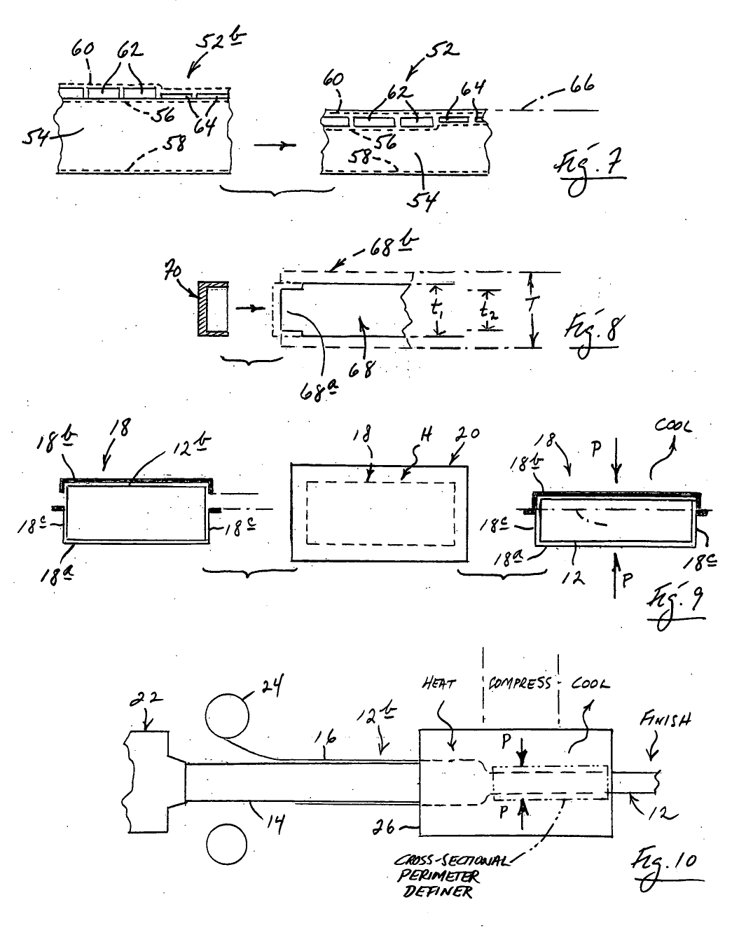

FIG. 6 shows generally yet another thermoforming practice which results in a final structural panel 50 having three, different, location-specific thicknesses t₁, t₂, t₃. Panel 50 began its life as a differentiated-thickness layer-stack assembly 50b which was prepared with three, different, pre-consolidation layer-stack thicknesses T₁, T₂, T₃. With respect to this thermoforming practice, as illustrated in FIG. 6, one should note that the end-result portions of panel 50 having the post-consolidation thicknesses ti, t₂, t₃, have resulted, respectively, from the pre-consolidation layer-stack regions having the thicknesses T₁, T₂, T₃.

Looking carefully at what has thus just been described with respect to FIG. 6, one can see that, regarding the pre-consolidation location-specific thicknesses T₁, T₂, T₃, in relation to relative sizes, T₃ is greater than T₂, and that T₂ is greater than T, with the left-to-right order in FIG. 6 associated with these “starting” thicknesses is T₁, T₃, T₂, whereas, in finally-produced panel 50, T₃ is greater than T₁, and T₂ is less than T₁, with the left-to-right order in FIG. 6 of these end-result panel thicknesses also being T₁, T₃, T₂. How and why such differentiated starting and ending thicknesses may be utilized and come about will now become more fully apparent in conjunction particularly with the description of FIG. 7.

FIG. 7, on its right side, shows, fragmentarily, a finished structural panel 52 which has resulted from the thermoforming of an initial, pre-consolidation layer-stack 52b shown on its left side. Panel 52 is an armoring panel, as will shortly be more fully discussed, and in particular, is what may be thought of as being an intentionally designed, spatially-differentiated, armoring-response panel.

Thus, panel 52 includes a central core layer 54 formed of PET material, three plural sub-layer fibre-reinforced, Polystrand® layers 56, 58, 60, and intermediate Polystrand® layers 56, 60, a layer of differentiated-thickness (two thicknesses are shown) ceramic armoring tiles, including thicker tiles 62 and thinner tiles 64. With respect to finished panel 52, a design decision has been made to produce this panel with a strike surface lying in a plane shown on the right side of FIG. 7 by a dash-dot line 66. This has been accomplished generally in the thermoforming approach illustrated, as earlier mentioned herein, in FIG. 5 in the drawings, and namely, from a differentiated-thickness, pre-consolidation assembly of layer components. This differentiated-thickness pre-consolidation layer-stack wherein, initially, Polystrand® layer 56 lies in a plane, differentiated-thickness ceramic tiles 62, 64 define an upwardly facing step in FIG. 7, which step is telegraphed into overlying Polystrand® layer 60. During compression consolidation, in accordance with practice of the present invention, to form panel 52, greater compression-produced thickness reduction occurs in the panel region associated, as can be seen, with thicker armoring tiles 62 than occurs in the panel region associated with thinner armoring tiles 64, with the attendant fact that tiles 62 become more deeply “driven” into the body of finished panel 52 than do tiles 64, thus to achieve a planar strike face illustrated by previously mentioned line 66. Also, and as can be seen on the right side of FIG. 7, Polystrand® layer 56 loses its initial, generally planar disposition to have, in final panel 52, the obviously seen stepped condition.

Finally referring to FIG. 8, which, as mentioned earlier, is related to the thermoforming approach pictured in FIG. 4, here a finally produced structural panel 68, having a stepped-dimension edge 68a, has resulted from a pre-consolidation layer-stack assembly, of substantially uniform location-specific thickness, 68b. More specifically, layer-stack 68b has a substantially uniform, overall, location-specific thickness T, with end-result panel 68 having two different location-specific consolidation thicknesses t₁, t₂. Thickness t₁, which characterizes, generally, the overall broad-expanse central region of panel 68, is larger than thickness t₂, which characterizes the thickness of what is the panel's perimetral edge 68a. This kind of panel configuration conveniently accommodates separate-component edge trimming of panel 68 by an edge-trimming component such as that shown at 70, thus to produce a final structural panel combination whose opposite, broad faces, including the portions of those faces defined by attached edge-trimming components, each lying in substantially continuous planes.

The unique thermoforming methodology has thus been described and illustrated for the creation of lightweight, strong, versatile and easily surface and edge topographical structural panels. Appropriate panel bulk is contributed principally by the incorporation of low-density, lightweight thermoformable foam material, such as the PET material mentioned. Great strength for load bearing and surface abrasion resistance, among other things, is/are contributed by the thermal bonding to the low density material of the high density, fibre-reinforced Polystrand® material mentioned. While the basic, or central, thermoforming practice of the invention focuses on the important assembling relationship of the two-layer arrangement, it is understood that many more layers may be employed, including layers which are not made of thermoformable materials. In this context, it should be noted that a structural panel may be formed in accordance with practice of the present invention, including a definable, alternating arrangement of low-density and high-density thermoformable materials (not specifically pictured in the drawings) wherein the confronting, next-adjacent faces of these layers become thermally bonded as described above.

Compression is always utilized as a step in the practice of the invention, both to achieve a controlled, final structural panel configuration, and to provide assistance in the establishment of robust thermal bonds between the employed, thermoformable layer materials. It should also be noted that, if desired, it is entirely possible to utilize, not only panel-edge-defining restraint during compression and cooling in the practice of the invention, but may also be employed along the edges of a forming panel to furnish another level of producible edge definition. As noted earlier herein, it is important that whatever structure is specifically employed to compress, shape, and boundary-define a structural panel during the thermoforming process, these panel-formation constraints should be retained during the cooling phase of the practice of the invention in order to assure a finally fully dimensionally stabilized, end-result structural panel.

Accordingly, and while a preferred manner of practicing the invention, and several modifications thereof, have been illustrated and described herein, other modifications may be made which will come within the scope of the claims to invention included herein without departing from the spirit of the invention.

We claim:

1. A method of forming a layered, composite-material structural panel having predefined, desired, final panel-thickness characteristics comprising
establishing a pre-consolidation, layer-stack assembly in the form of a pre-consolidation expanse having everywhere a location-specific, pre-selected, pre-consolidation, independent, local thickness T, and including at least a pair of confronting, next-adjacent, different-thermoformable-material layers,
heating the established assembly to a predetermined thermoform temperature,
compressing the heated assembly to consolidate it so as (a) to form a post-consolidation expanse having everywhere a location-specific, pre-selected, post-consolidation, independent, local thickness t which is less than the respective, associated, pre-selected, pre-consolidation local thickness T, and which takes the form of the desired, predefined final panel-thickness characteristics, and (b) to create a thermal bond between the two layers,
cooling the consolidated assembly to a predetermined sub-thermoform temperature to stabilize it in its consolidated condition, and
by said cooling, completing, substantially, the formation of the intended structural panel.

2. The method of claim 1 which is performed in a manner whereby (a) the respective, pre-consolidation, location-specific, local expanse thicknesses T are all substantially the same, and (b) the respective, post-consolidation, location-specific, local expanse thicknesses t are also all substantially the same.

3. The method of claim 1 which is performed in a manner whereby (a) the respective, pre-consolidation, location-specific, local expanse thicknesses T are all substantially the same, and (b) at least certain ones of the respective, post-consolidation, location-specific, local expanse thicknesses t differ from one another.

4. The method of claim 1 which is performed in a manner whereby (a) at least certain ones of the respective, pre-consolidation, location-specific, local expanse thicknesses T differ from one another, and (b) the respective, post-consolidation, location-specific, local expanse thicknesses t are also all substantially the same.

5. The method of claim 1 which is performed in a manner whereby (a) at least certain ones of the respective, pre-consolidation, location-specific, local expanse thicknesses T differ from one another, and (b) ) at least certain ones of the respective, post-consolidation, location-specific, local expanse thicknesses t also differ from one another.

6. The method of claim 1, wherein said establishing is augmented by including in the pre-consolidation layer-stack assembly at least one additional material layer which is non-interposed the first two mentioned layers, and which is made of at least one of (a) a non-thermoformable material, and (b) a thermoformable material.

7. The method of claim 6, wherein said including involves preparing the mentioned augmenting-material layer to have a distributed, differentiated-thickness expanse characteristic.

8. The method of claim 1 which is performed in the context of selecting, for one of the two thermoformable-material layers, a PET material, and for the other layer, a strand-reinforced material which includes a distribution of angularly intersecting reinforcing strands blended with a thermoformable plastic which is thermo-bond-compatible with the PET-material layer.

9. The method of claim 8, which is performed in a context where one of the two thermoformable-material layers is thicker than the other thermoformable-material layer, and wherein the mentioned PET material is selected for use in the one, thicker layer, and the strand-reinforced material is selected for use in the other, thinner layer.

10. The method of claim 9, wherein all assembly thickness reductions from T to t at each specific assembly location during compression consolidation of the assembly occur with a greater thickness reduction taking place in the thicker PET layer than in the thinner strand-reinforced layer.

11. The method of claim 10, wherein said compressing is performed and completed in a manner whereby, at all locations in the assembly, the thicker PET layer is thickness-reduced by at least a predetermined, common thickness amount.

12. The method of claim 11, wherein said compressing is performed in a manner causing the mentioned predetermined thickness amount being about ⅛-inches.

13. The method of claim 8, wherein said selecting of a PET material involves choosing such a material which is non-internally-stranded.

14. A method of forming a layered, composite-material structural panel having predefined, desired, final panel-thickness characteristics comprising
establishing a pre-consolidation, layer-stack assembly in the form of a pre-consolidation expanse having everywhere a location-specific, pre-selected, pre-consolidation, independent, local thickness T, and featuring at least a plurality of confronting, next-adjacent, different-thermoformable-material layers, including a PET-material core layer sandwiched between a pair of strand-reinforced, opposite surfacing-material layers each of which surfacing-material layers includes a distribution of angularly intersecting reinforcing strands blended with a thermoformable plastic which is thermo-bond-compatible with the PET-material core layer,
heating the established assembly to a predetermined thermoform temperature,
compressing the heated assembly to consolidate it so as (a) to form a post-consolidation expanse having everywhere a location-specific, pre-selected, post-consolidation, independent, local thickness t which is less than the respective, associated, pre-selected, pre-consolidation local thickness T, and which takes the form of the desired, predefined final panel-thickness characteristics, and (b) to create thermal bonds between each next-adjacent pair of the three assembly layers,
cooling the consolidated assembly to a predetermined sub-thermoform temperature to stabilize it in its consolidated condition, and
by said cooling, completing, substantially, the formation of the intended structural panel.

15. The method of claim 14 which is performed in a manner whereby (a) the respective, pre-consolidation, location-specific, local expanse thicknesses T are all substantially the same, and (b) the respective, post-consolidation, location-specific, local expanse thicknesses t are also all substantially the same.

16. The method of claim 14 which is performed in a manner whereby (a) the respective, pre-consolidation, location-specific, local expanse thicknesses T are all substantially the same, and (b) at least certain ones of the respective, post-consolidation, location-specific, local expanse thicknesses t differ from one another.

17. The method of claim 14 which is performed in a manner whereby (a) at least certain ones of the respective, pre-consolidation, location-specific, local expanse thicknesses T differ from one another, and (b) the respective, post-consolidation, location-specific, local expanse thicknesses t are also all substantially the same.

18. The method of claim 14 which is performed in a manner whereby (a) at least certain ones of the respective, pre-consolidation, location-specific, local expanse thicknesses T differ from one another, and (b) ) at least certain ones of the respective, post-consolidation, location-specific, local expanse thicknesses t also differ from one another.
